(19) United States
(12) Patent Application Publication
(10) Pub. No.: US 2004/0122867 A1
(43) Pub. Date: Jun. 24, 2004

(54) Portable communication device having a file and data management system and method therefor

(76) Inventor: Paul C. Drews, Gaston, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/329,218

(22) Filed: Dec. 23, 2002

(51) Int. Cl. G06F 17/30

(52) U.S. Cl. 707/200

(57) ABSTRACT

Briefly, in accordance with one embodiment of the invention, a portable computing or communication device maintains a library of resource characteristics for files or data stored in the device. The characteristics may be used to identify which file should be deleted to make room for another file to be loaded. The characteristics may reflect information about how much of a cost or inconvenience a user may incur by having to later replace the deleted file.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawing in which:

FIG. 1 is a block diagram representation of a mobile device in accordance with an embodiment;

FIG. 2 is a logical model of a mobile device in accordance with an embodiment;

FIG. 3 is a flowchart of a method in accordance with an embodiment; and

FIG. 4 is a block diagram of an interface in accordance with an embodiment.

It will be appreciated that for simplicity and clarity of illustration, elements illustrated in the figure have not necessarily been drawn to scale. For example, the dimensions of some of the elements are exaggerated relative to other elements for clarity.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), Flash memory, magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

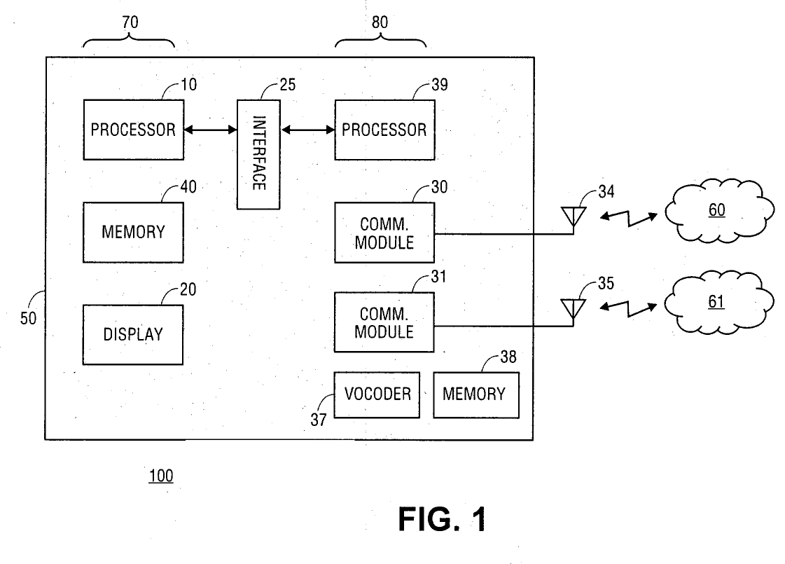

Turning to FIG. 1, an embodiment 100 in accordance with the present invention is described. Embodiment 100 may comprise a portable computing or communication device 50 such as a mobile communication device (e.g., cell phone), a two-way radio communication system, a one-way pager, a two-way pager, a personal communication system (PCS), a personal digital assistant (PDA), a portable computer, or the like. However, it should be understood that the scope and application of the present invention is in no way limited to these examples. Other embodiments of the present invention may include other computing systems that may or may not be portable or even involve communication systems such as, for example, desktop or portable computers, servers, network switching equipment, etc.

In this particular embodiment portable communication device 50 may include an application subsystem 70 and a communication subsystem 80 that are coupled together by an interface 25. Although the scope of the present invention is not limited in this respect, application subsystem 70 may be used to provide features and capabilities that are visible or used by a user such as, for example, email, calendaring, audio, video, gaming, etc. Communication subsystem 80 may be used to provide wireless and/or wired communication with other networks 60-61 such as, for example, cellular networks, wireless local area networks, etc.

An interface 25 may be used to provide communication or information between application subsystem 70 and communication subsystem 80. Although the scope of the present invention is not limited in this respect, interface 25 may comprise serial and/or parallel buses to share information along with control signal lines to be used to provide handshaking between application subsystem 70 and communication subsystem 80.

However, it should be understood that the use of interface 25 should be considered optional. In addition, the scope of the present invention is not limited so as to require both application subsystem 70 and communication subsystem 80. In alternative embodiments, a portable communication device may have just one or the other. Further, yet other embodiments may have one processor that provides the capabilities of both.

In this particular embodiment, application subsystem 70 may include a processor 10 that may execute instructions such as instructions stored in a memory 40. Processor 10 may be one of a variety of integrated circuits such as, for example, a microprocessor, a central processing unit (CPU), a digital signal processor, a microcontroller, a reduced instruction set computer (RISC), a complex instruction set computer (CISC), or the like, although the scope of the present invention is not limited by the particular design or functionality performed by processor 10. In addition, in some alternative embodiments, application subsystem 70 may comprise multiple processors that may be of the same or different type.

Portable communication device 50 may also comprise memory 40 that may comprise any variety of volatile or non-volatile memory such as any of the types of storage media recited earlier, although this list is certainly not meant to be exhaustive and the scope of the present invention is not limited in this respect. Memory 40 may comprise persistent memory to be used to store sets of instructions such as instructions associated with an application program, an operating system program, a communication protocol program, etc. For example, the instructions stored in memory 40 may be used to perform wireless communications, provide security functionality for portable communication device 50, user functionality such as calendaring, email, internet browsing, etc.

Application subsystem 70 may also comprise a display 20 to provide information to a user and communication modules 30-31 to provide access to other devices, service, networks, etc. Alternatively or in addition, application subsystem may include other components such as input/output devices, audio outputs, etc. However it should be understood that the scope of the present invention is not limited so as to require any particular combination of components shown in FIG. 1.

Communication subsystem 80 may include a baseband processor 39, such as one of the types described above and communication modules 30-31 that may be used to allow portable communication device 50 to communicate with other networks through either a wired or wireless link. As shown, communication modules 30-31 may use antennae 34-35 to wirelessly communicate with networks 60-61.

Although the scope of the present invention is not limited in this respect, communication modules 30-31 may employ a variety of wireless communication protocols such as cellular (e.g. Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like).

In addition, communication modules may use other wireless local area network (WLAN), wide area network (WAN), or local area network (LAN) protocols such as the Industrial Electrical and Electronics Engineers (IEEE) 802.11 standard, Bluetooth™, infrared, etc. (Bluetooth is a registered trademark of the Bluetooth Special Interest Group).

It should be understood that the scope of the present invention is not limited by the types of, the number of, or the frequency of the communication protocols that may be used by portable communication device 50. Furthermore, alternative embodiments may have more than two communication modules (either wired or wireless) and communication modules need not have separate antennae, and some or all may share a common antenna.

It should also be understood that communication subsystem 80 may include other optional components such as, for example, a vocoder 37 to encode voice data or memory 38 Memory 38 may comprise one or more of the memory types described above.

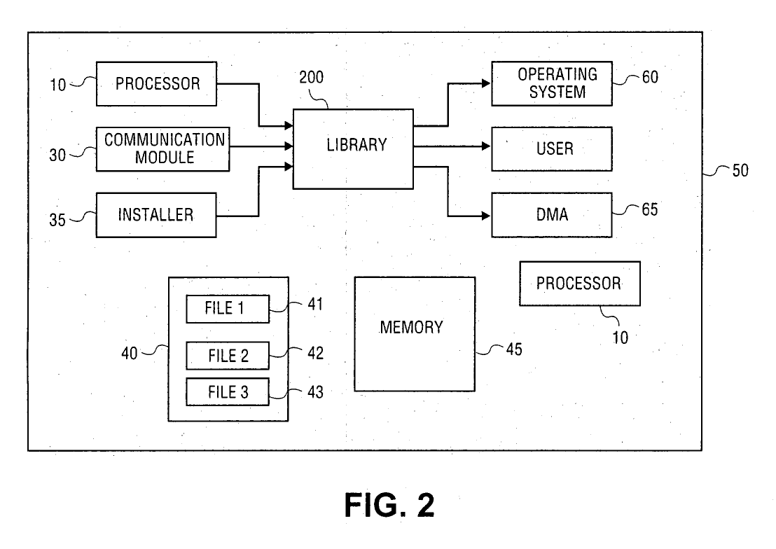

Turning to FIG. 2, a particular embodiment of the present invention is provided. FIG. 2 is a logical model diagram representing the relationships and interactions between operations that may take place within portable communication device 50. It should be understood that operations or features illustrated in FIG. 2 may be implemented with any combination of hardware and software. In other embodiments, operations shown in FIG. 2 and/or discussed below may be implemented entirely in hardware or entirely in software. Furthermore, the portions of the operations that are implemented, at least in part, with software may be implemented through an operating system, user applications, firmware, etc., although the scope of the present invention is not limited to just these examples.

Although the scope of the present invention is not limited in this respect, during the operation of portable communication device 50, persistent memory 40 may be used to store files 41-43 that may comprise a variety of information to be used by portable device 50. For example, files 41-43 may represent at least a portion of a user data file, operation system program, application program, security data,

It may be desirable to occasionally or periodically add files or data to memory 40. For example, the user of portable communication device 50 may want to download information or a new program/resource into portable device 50 for storage in memory 40. Prior to installing the new program or data, some of files 41-43 may be removed to provide for the additional storage. As explained in more detail below, portable communication device 50 may provide assistance in identifying which file or files 41-43 should be deleted so as to reduce the impact on the user.

Although the scope of the present invention is not limited in this respect, portable communication device 50 may maintain a library 200 of resource characteristics of the data or files stored within portable communication device 50. The number or the extent of information stored in library 200 may vary, as desired, and include some or all of the following. For example, library 200 may comprise resource characteristics such as the usage of files 41-43. The usage may be tracked so that the usage represents an actual usage. Alternatively, the usage may be predictive in nature based on various factors so that the usage may be predicted on the operational mode, user preferences, quality of service provided by a network, etc.

Additionally or alternatively, library 200 may maintain the source of files 41-43, the cost to replace files 41-43 in portable communication device 50,or the amount of time to replace files 41-43, although the scope of the present invention is not limited in this respect. For example, library 200 may keep track of where files 41-43 came from or where they are likely to be replaced from (e.g. network source, hardware source, etc.). The resource characteristics may also keep track of the costs in time, money, and/or convenience that may be incurred by the user of portable communication device 50. For example, library 200 may maintain data such as the number of packets or amount of time it would take to replace the file, or alternatively, total amount that may be charged, etc, although the scope of the present invention is not limited in this respect.

Additionally or alternatively, library 200 may maintain resource characteristics associated with the amount of temporary memory space needed to execute files 41-43, the relative ease to replace files 41-43, and predicted usage of the first file. Although the scope of the present invention is not limited in this respect, portable communication device 50 may include a volatile memory 45 such as, for example, any of the volatile memory types described above.

During the operation of portable device 50, at least some of the files 41-43 may be optionally copied to a volatile memory 45 for a variety of reasons. Although the scope of the present invention is not limited in this respect, files or data may be copied to memory 45 so that they may be altered or access faster by processor 10. Consequently, library 200 may store information such as the size of the files, memory requirements, the type of the data or file (e.g. voice data, user data, program instruction, program data, etc.),or typical or average amount of memory used, etc.

It should be understood that the scope of the present invention is not limited to embodiments where the resource characteristics maintained are associated with files or data. In alternative embodiments, information or characteristics for other features of portable communication device 50 may also be maintained. For example, library 200 may comprise information associated with other software features such as applets, cookies, etc. Additionally or alternatively, library 200 may comprise information associated with the hardware of portable communication device 50 such as, for example, display 20, processing capabilities, network connectivity hardware, peripheral resource availabilities, etc.

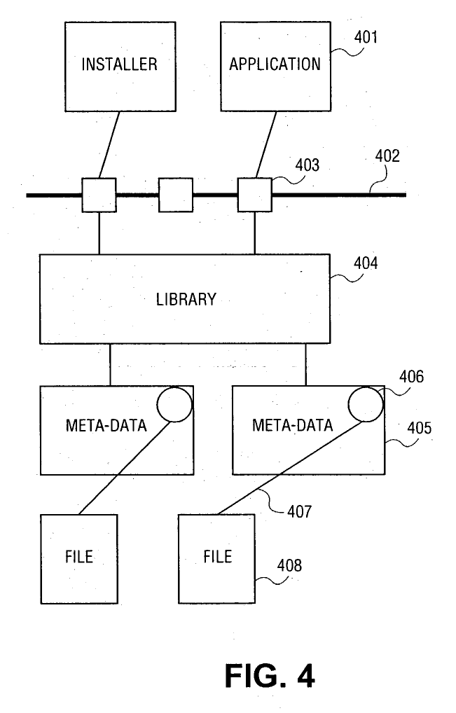

With reference now to FIG. 4, a particular embodiment of the present invention is provided. Although the scope of the present invention is not limited in this respect, in this particular embodiment an interface may allow components to be developed separately from one another and still be able to interoperate with one another successfully. FIG. 4 illustrated one or more clients 401 that may be coupled to an interface 402. Examples of clients 401 may include, but are not limited to, Application Installers, Applications, Application Downloaders, Backup/Restore utilities, Application acquisition utilities such as a program that assists a user in shopping for and purchasing new applications, etc.

Interface 402 may provide a variety of operations 403 described in more detail below. The actual capabilities represented by the operations 403 are supplied by one or more libraries 404. A library 404 may comprise one or more pieces of meta-data 405 that may give information about one or more Files 408.

Although the scope of the present invention is not limited by the type of nature of meta-data 405, in one particular embodiment meta-data 405 may record an association 407 between one or more files 408 and one or more resource type tags 406. Interface 402 may predefine particular resource type tags 406, and may allow extension of the set of resource type tags. For example, tags 406 may include but are note limited to: “application installation data”, “user data”, “application setting or configuration”, “temporary persistent storage”, “persistent storage”, “volatile storage (e.g. RAM)”.

Although the clients 401, interface, 402, operations 403, library 404, meta-data 405, and files 408 are described as separate components for the purpose of illustration, one skilled in the art will recognize that these components may be integrated in a variety of ways that may not involve separation between one component and another. For example, it is possible that a single component may at times act in the role of a client 401 such as an installer and at other times act in the role of a library 404.

Interface 402 may be embodied in a variety of different ways including but not limited to the following: a set of software procedures that may be called and that have a defined syntax and semantics, A set of messages and replies that may be sent and received and that have a defined syntax and semantics, A protocol for interaction between elements with defined syntax and semantics, or Serial or parallel busses along with control signal lines.

The set of operations 403 provided by the interface 402 may differ from one embodiment to another. Although the scope of the present invention is not limited in this respect, some embodiments may include: operations to install an application where there is an option to retain user data from a previous installation, or to create an empty user-data repository or subsequent restoration from archived user data, an operation to remove an application where there is an option to keep or remove associated user data or application settings or configuration, an operation to create, update, retrieve, and remove an association between a file (or other unit of storage) and one or more type classifications, an operation to create, update, retrieve, and remove an association between a user-data file and an application that is used to manipulate that user data, an operation to create, update, retrieve, and remove an association between a user-settings or configuration file and an application that shall behave according to those user-settings or configuration, an operation to create, update, retrieve, and remove an association between a storage resource requirement quantity, a storage resource type, and an application, an operation to retrieve the system's available resource quantities for storage resource type classifications, etc.

Similarly, the associations 407 that may be recorded by meta-data 405 may include types of associations corresponding to the operations described above. However, this set of operations or types of associations should not be construed as limiting. The set of operations or types of associations provided in other embodiments may omit some of these, and it may include functions or types of associations outside this set. Moreover, an embodiment may allow the set of operations or types of associations to be extended.

Similarly, meta data 405 may be embodied in a variety of different ways. Non-limiting examples of meta-data embodiments include: a data base, a data format within ordinary files, an attachment of auxiliary data to files, a technique that implicitly embodies the data in the structure of a file system (e.g., user-data for an application might be all in a sub-directory of the application's installation directory), putting the data in EEPROM or Flash, putting the data in a table, or putting the data in a registry.

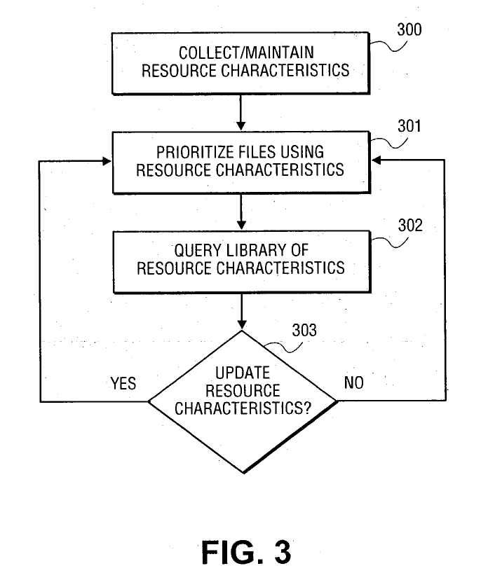

With reference now to FIG. 3, a method in accordance with an embodiment of the present invention is provided. To begin, resource characteristics information may be created or maintained, box 300. Although the scope of the present invention is not limited in this respect, resource characteristics information may be stored in library 200 as a data file, in a table, in registers/latches, etc. Alternatively, library 200 may represent a combination of both software and hardware, such as an application programming interface API, so that the particular storage mechanism is transparent to the hardware and/or software that provides the resource characteristics information.

Resource characteristics information may be provided from a variety of sources and it should be understood that the scope of the present invention is not limited by the source. For example, as files 41-43 are stored in memory 45 (see FIG. 2), the corresponding resource characteristics may be stored in library 200. The information may come from the installation program (e.g. installer 35) that installed the program within portable communication device 50 or from the firmware, basic input/output software (BIOS), operating system, etc.

Additionally or alternatively, resource characteristics information may be provided dynamically while portable communication device 50 is in operation and after files 41-43 have been loaded into memory 45. For example, processor 10 may provide or update resource information depending on the operational capabilities of portable communication device 50 that may change with time or as other hardware and/or software is added. Alternatively, a communication module 30 may update resource characteristics information that may be based, at least in part, on the network(s) with which portable communication device 50 is in communication.

Portable communication device 50 may then use all or at least a portion of the resource characteristics information of library 200 to prioritize files 41-43, box, 301, although the scope of the present invention is not limited in this respect. For example, the resource characteristics information may be used to identify which of files 41-43 should be deleted if more space is desired. Alternatively, files 41-43 may be prioritized in order of importance, order of increasing/decreasing cost to be incurred by a user to replace the files, increasing/decreasing order of the amount of time or inconvenience incurred by a user to replace the files through a wireless or wires connection, etc.

It should be understood that the scope of the present invention is not limited to how files 41-43 are prioritized using the resource characteristics in library 200. In addition, it should be understood, that prioritization may occur when any of the resource characteristics are added/modified, or optionally, prioritization may occur periodically during the operation of portable communication device 50. In yet other embodiments, prioritization may occur when library 200 is queried regarding the information stored in library 200 as part of a file management operation. In addition, it should be understood that the scope of the present invention is not limited to devices that perform prioritization. In other embodiments, the resource characteristics of library 200 may be used without performing any prioritization.

For example, although the scope of the present invention is not limited in this respect, library 200 may be queried by an operating system 60 if there is a need to move a file into memory 40, update a file in memory 40, or delete a file from memory 40, box 302. Alternatively, library 200 may be queried during other file management operations such as during a reclaiming operation of memory, as part of a backup operation, as part of an operation to relocate all or part of a file/data from memory 40 to memory 45, or vice-versa, or other file management operations.

Additionally or alternatively, library 200 may be queried by the user of portable communication device 50. This may be done, for example, if the user would like to add a new program, data file, hardware, software, service, etc. into portable communication device 50. Thus, the user may decide for himself or herself what file management operations should be performed based on the information available by library 200.

Optionally, portable communication device 50 may make a recommendation as to which of files 41-43 should be deleted. The recommendation may be based on a prioritization process as described above, box 301, or may be made on other factors indicated to be important by the user. For example, the user may indicate that factors such as cost, download time, or security is very important and portable communication device 50 may poll library 200 and make a recommendation based on those factors. Thus, a file management operation may be performed (e.g. a file may be deleted) based on a recommendation provided by portable communication device 50, or based on a decision made by the user, although the scope of the present invention is not limited in this respect.

It should be understood that the resource characteristics information stored in library 200 may be utilized by other hardware and/or software within portable communication device 50. For example, the information may be used by a direct memory access (DMA) engine 65 to assist in the transferring of data, instructions, etc. within the memory system of portable communication device 50. Alternatively, the resource characteristics information of library 200 may be used by external devices such as, for example, the network with which portable communication device is in communication.

In this particular embodiment, after a file management operation is performed, the corresponding resource characteristics information in library 200 may be updated, box 303. For example, if a file as been added, modified, or move, the information may be updated accordingly, although the scope of the present invention is not limited in this respect. In addition, the resource characteristics information may be updated periodically or upon any changes within portable communication device 50 or the network.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method of managing a first file and a second file in a portable communication device, comprising:
maintaining a library of resource characteristics of the first file and the second file in the portable communication device.

2. The method of claim 1, further comprising prioritizing the first file above the second file for a file management operation.

3. The method of claim 2, further comprising performing the file management operation by deleting the first file from a memory.

4. The method of claim 2, further comprising performing the file management operation by relocating the first file to a persistent memory.

5. The method of claim 4, further comprising storing the first file into a flash memory array.

6. The method of claim 1, wherein maintaining a library of resource characteristics includes maintaining a library comprising a resource characteristic selected from the group comprising: usage of the first file and the second file, source of the first file and the second file, cost to replace the first file and the second file, and the time to replace the first file and the second file.

7. The method of claim 6, wherein maintaining a library of resource characteristics includes maintaining a library comprising a resource characteristic selected from the group further comprising: amount of temporary memory space needed to execute the first file, relative ease to replace the first file, and predicted usage of the first file.

8. The method of claim 1, further comprising recommending which of the first file and the second file should be deleted based on the library of resource characteristics.

9. The method of claim 1, further comprising querying the library of resource characteristics to provide at least a portion of information in the library of resource characteristics.

10. The method of claim 9, wherein querying the library of resource characteristics includes querying the library of resource characteristics with a request from an operating system.

11. The method of claim 9, wherein querying the library of resource characteristics includes querying the library of resource characteristics with a request from a user of the portable communication device.

12. The method of claim 1, further comprising loading a third file into the portable communication device via a wireless communication.

13. The method of claim 12, further comprising updating the library of resource characteristics with information associated with the third file.

14. The method of claim 1, wherein maintaining a library of resource characteristics of the first file and the second file includes maintaining a library of resource characteristics of a data file and an application file.

15. A computing device comprising:
a memory to store a first file and a second file; and
a library to store a cost to a user to replace the first file and the second file.

16. The computing device of claim 15, wherein the cost to a user reflects the amount of time needed to replace the first file and the second file via a wireless communication.

17. The computing device of claim 15, wherein the cost to a user reflects the amount of time needed to replace the first file and the second file via a wired communication.

18. The computing device of claim 15, wherein the cost to a user reflects the amount charged to the user to replace the first file and the second file via a wireless communication.

19. The computing device of claim 15, wherein the library is further adapted to store characteristics of the first file and the second file.

20. The computing device of claim 19, wherein the computing device is further adapted to recommend which of the first file and the second file should be deleted based on the characteristics.

21. A portable computing device comprising a storage medium having stored thereon instructions, that, when executed by a computing platform, results in:
maintaining a library of resource characteristics of a first file and a second file stored in the portable computing device.

22. The article of claim 21, wherein the instructions, when executed, further result in:
prioritizing the first file above the second file based on at least a portion of the resource characteristics in the library.

23. The article of claim 22, wherein the instructions, when executed, further result in deleting the first file from a memory.

24. The article of claim 22, wherein the instructions, when executed, further result in relocating the first file to a persistent memory.

25. The article of claim 22 wherein the instructions, when executed, further result in recommending which of the first file and the second file should be deleted based on the library of resource characteristics.

26. The article of claim 21, wherein the instructions, when executed, further result in querying the library of resource characteristics to provide at least a portion of information in the library of resource characteristics.

27. The article of claim 21, wherein the instructions, when executed, further result in loading a third file into the portable computing device via a wireless communication.

28. The article of claim 27, wherein the instructions, when executed, further result in updating the library of resource characteristics with information associated with the third file.
